(19) United States
(12) Patent Application Publication
(10) Pub. No.: US 2018/0326998 A1
(43) Pub. Date: Nov. 15, 2018

(54) STOP INTENTION DETERMINATION APPARATUS AND STOP INTENTION DETERMINATION METHOD

(71) Applicant: OMRON Corporation, Kyoto-shi (JP)

(72) Inventors: Hatsumi AOI, Kyotanabe-shi (JP); Kazuyoshi OKAJI, Omihachiman-shi (JP); Hiroshi SUGAHARA, Kyoto-shi (JP); Michie UNO, Kyoto-shi (JP); Koji TAKIZAWA, Kyoto-shi (JP)

(73) Assignee: OMRON Corporation, Kyoto-shi (JP)

(21) Appl. No.: 15/949,157

(22) Filed: Apr. 10, 2018

(30) Foreign Application Priority Data
May 9, 2017 (JP) 2017-092846

(51) Int. Cl. B60W 50/10; G10L 15/22; B60Q 1/46

(52) U.S. Cl. CPC B60W 50/10; G05D 1/0088; B60Q 1/46; G10L 15/22

(57) ABSTRACT

A stop intention determination apparatus is mounted in a vehicle provided with an autonomous driving mode and determines an intention of a driver to stop the vehicle during driving in the autonomous driving mode. The stop intention determination apparatus includes: an input signal acquiring portion configured to acquire an input signal from a hazard lamp switch during driving in the autonomous driving mode; a stop intention determining portion configured to determine the intention of the driver to stop the vehicle based on the acquired input signal; and a signal output portion configured to output a signal for giving an instruction to stop the vehicle through autonomous driving to an autonomous driving control apparatus, if it is determined by the stop intention determining portion that the input signal is a signal indicating the intention of the driver to stop the vehicle.

### CROSS-REFERENCES TO RELATED APPLICATIONS

This application claims priority to Japanese Patent Application No. 2017-092846 filed on May 9, 2017, the entire contents of which are incorporated herein by reference.

### FIELD

The disclosure relates to a stop intention determination apparatus and a stop intention determination method, and relates more particularly to a stop intention determination apparatus that is mounted in a vehicle provided with an autonomous driving mode and determines an intention of a driver to stop the vehicle during driving in the autonomous driving mode, and a stop intention determination method.

### BACKGROUND

In recent years, research and development have been actively conducted to realize autonomous driving, i.e. autonomously controlling traveling of a vehicle. Autonomous driving technology is classified into several levels, ranging from a level at which at least part of traveling control, which includes acceleration and deceleration, steering, and braking, is automated, to a level of complete automation.

At an automation level at which vehicle operations and peripheral monitoring are performed by an autonomous driving system (e.g. level 3 at which acceleration, steering, and braking are entirely performed by the autonomous driving system, and a driver performs control when requested by the autonomous driving system), a situation is envisioned where an autonomous driving mode is switched to a manual driving mode in which the driver drives the vehicle, depending on factors such as the traffic environment. It is, for example, a situation where, although autonomous driving is possible on an expressway, the autonomous driving system requests the driver to manually drive the vehicle near an interchange.

In the autonomous driving mode at the aforementioned level 3, the driver is basically relieved from performing driving operations, and accordingly, the driver may perform an operation other than driving or may be less vigilant during autonomous driving. For this reason, in a situation where the autonomous driving mode is switched to the manual driving mode, a significant operation burden may be placed on the driver. To address this problem, for example, Patent Documents 1 and 2 listed below disclose an autonomous driving assistance apparatus capable of reducing such a burden on the driver when autonomous driving is switched to manual driving.

There are also conceivable cases where the driver wants to stop the vehicle at any timing during autonomous driving at an automation level at which an autonomous driving system operates the vehicle and monitors the surroundings thereof.

The techniques disclosed in Patent Documents 1 and 2 can reduce the burden placed on the driver when autonomous driving is switched to manual driving. However, for example, control performed in the case of stopping the vehicle at any timing during autonomous driving is not particularly disclosed.

In a situation where a vehicle is stopped at any timing during autonomous driving, for example, a method in which autonomous driving is switched to manual driving and the driver stops the vehicle through manual driving, and a method in which a route change operation to change a stopping place that is set for autonomous driving is performed, are conceivable.

However, both methods involve operations that may annoy the driver who is relieved from driving operations during autonomous driving, and will bother the driver.

JP 2017-030546A and JP 2016-091412A are examples of background art.

### SUMMARY

One or more embodiments have been made in view of the foregoing problem, and aims to provide a stop intention determination apparatus that can determine an intention of the driver to stop the vehicle during driving in the autonomous driving mode, and stop the vehicle through autonomous driving control without bothering the driver.

To achieve the above-stated object, a stop intention determination apparatus (1) according to one or more embodiments is a stop intention determination apparatus that is mounted in a vehicle provided with an autonomous driving mode and determines an intention of a driver to stop the vehicle during driving in the autonomous driving mode, the apparatus including:

an input signal acquiring portion configured to acquire a signal from a predetermined input portion provided in the vehicle during driving in the autonomous driving mode;

a stop intention determining portion configured to determine the intention of the driver to stop the vehicle based on the signal from the predetermined input portion acquired by the input signal acquiring portion; and a signal output portion configured to output a signal for giving an instruction to stop the vehicle through autonomous driving to an autonomous driving control portion that performs control in the autonomous driving mode, if it is determined by the stop intention determining portion that the signal from the predetermined input portion is a signal indicating the intention of the driver to stop the vehicle.

With the above-described stop intention determination apparatus (1), the intention of the driver to stop the vehicle during driving in the autonomous driving mode is determined based on the signal from the predetermined input portion acquired by the input signal acquiring portion. If it is determined that the signal from the predetermined input portion is a signal indicating the intention of the driver to stop the vehicle, the signal for giving an instruction to stop the vehicle through autonomous driving is output to the autonomous driving control portion. Accordingly, the vehicle can be stopped through autonomous driving control during driving in the autonomous driving mode, without bothering the driver.

A stop intention determination apparatus (2) according to one or more embodiments is the above-described stop intention determination apparatus (1), in which the predetermined input portion is a hazard lamp switch provided in the vehicle, and the stop intention determining portion determines the intention of the driver to stop the vehicle based on a state of an input signal from the hazard lamp switch acquired by the input signal acquiring portion.

With the above-described stop intention determination apparatus (2), the intention of the driver to stop the vehicle is determined during driving in the autonomous driving mode based on the state of the input signal from the hazard lamp switch. If it is determined that the signal from the hazard lamp switch is a signal in a state indicating the intention of the driver to stop the vehicle, the signal for giving an instruction to stop the vehicle through autonomous driving is output to the autonomous driving control portion. Accordingly, the vehicle can be stopped through autonomous driving control during driving in the autonomous driving mode with a simple operation by operating the hazard lamp switch, without bothering the driver. In addition, since the hazard lamp switch is mounted in normal vehicles, the use of the hazard lamp switch requires no new operation switch to be mounted in the vehicle, and can reduce the area for mounting operation switches and the like.

Furthermore, since the hazard lamp switch usually allows people to imagine stopping of a vehicle, the driver does not need to memorize special operations or functions to carry out one or more embodiments, and a user-friendly apparatus can be provided.

A stop intention determination apparatus (3) according to one or more embodiments is the above-described stop intention determination apparatus (2), in which, if the input signal from the hazard lamp switch is a signal in a state of causing a hazard lamp to blink a predetermined number of times or more, or for a predetermined time or longer, the stop intention determining portion determines that the driver intends to stop the vehicle.

With the above-described stop intention determination apparatus (3), if the input signal from the hazard lamp switch is a signal in a state of causing the hazard lamp to blink a predetermined number of times or more, or for a predetermined time or longer, it is determined that the driver intends to stop the vehicle. Accordingly, for example, the intention of the driver to stop the vehicle can be determined in distinction from a switch operation to cause the hazard lamp to blink for a short time to express gratitude to a nearby vehicle that has given way to the driver or the like.

A stop intention determination apparatus (4) according to one or more embodiments is the above-described stop intention determination apparatus (2), further including: a travel distance calculating portion configured to calculate a travel distance of the vehicle, wherein, if the travel distance calculated by the travel distance calculating portion reaches a predetermined distance while the input signal from the hazard lamp switch is acquired by the input signal acquiring portion, the stop intention determining portion determines that the driver intends to stop the vehicle.

With the above-described stop intention determination apparatus (4), if the travel distance reaches the predetermined distance while the input signal from the hazard lamp switch is acquired, it is determined that the driver intends to stop the vehicle. Accordingly, substantially the same effects as those of the above-described stop intention determination apparatus (3) can be obtained.

A stop intention determination apparatus (5) according to one or more embodiments is the above-described stop intention determination apparatus (1), in which the predetermined input portion is a voice input portion provided in the vehicle, the stop intention determination apparatus further includes a voice recognition processing portion configured to perform processing to recognize a voice signal from the voice input portion acquired by the input signal acquiring portion, and if a voice recognized by the voice recognition processing portion is a voice indicating an intention to stop the vehicle, the stop intention determining portion determines that the driver intends to stop the vehicle.

With the above-described stop intention determination apparatus (5), the intention of the driver to stop the vehicle is determined during driving in the autonomous driving mode, based on the result of recognizing the voice signal from the voice input portion. If it is determined that the voice recognized by the voice recognition processing portion indicates the intention of the driver to stop the vehicle, the signal for giving an instruction to stop the vehicle through autonomous driving is output to the autonomous driving control portion. Accordingly, the vehicle can be stopped with voice input via the voice input portion through autonomous driving control during the autonomous driving mode, without bothering the driver.

A stop intention determination apparatus (6) according to one or more embodiments is the above-described stop intention determination apparatus (1), in which the predetermined input portion is a turn signal switch provided in the vehicle, and the stop intention determining portion determines the intention of the driver to stop the vehicle based on a state of an input signal from the turn signal switch acquired by the input signal acquiring portion.

With the above-described stop intention determination apparatus (6), the intention of the driver to stop the vehicle is determined during driving in the autonomous driving mode, based on the state of the input signal from the turn signal switch. If it is determined that the signal from the turn signal switch is a signal in a state indicating the intention of the driver to stop the vehicle, the signal for giving an instruction to stop the vehicle through autonomous driving is output to the autonomous driving control portion. Accordingly, the vehicle can be stopped with an operation to the turn signal switch through autonomous driving the autonomous driving mode, without bothering the driver. In addition, since the turn signal switch is mounted in usual vehicles, the use of the turn signal switch requires no new operation switch to be mounted in the vehicle, and can reduce the area for mounting operation switches or the like. Furthermore, since the turn signal switch usually is for notifying nearby people of an intention of the driver to change the course of the vehicle, for example, the driver does not need to memorize special operations or functions to carry out one or more embodiments, and a user-friendly apparatus can be provided.

A stop intention determination apparatus (7) according to one or more embodiments is the above-described stop intention determination apparatus (6), in which, if the input signal from the turn signal switch is a signal in a state of causing a turn signal lamp indicating a road shoulder direction to blink, and causing the turn signal lamp to blink a predetermined number of times or more, or for a predetermined time or longer, the stop intention determining portion determines that the driver intends to stop the vehicle.

With the above-described stop intention determination apparatus (7), if the input signal from the turn signal switch is a signal in a state of causing a turn signal indicating a road shoulder direction to blink, and causing the turn signal to blink a predetermined number of times or more, or for a predetermined time or longer, it is determined that the driver intends to stop the vehicle. Accordingly, the intention of the driver to stop the vehicle can be determined, in distinction from a course change toward a passing lane, for example.

A stop intention determination method according to one or more embodiments is a stop intention determination method for determining an intention of a driver to stop a vehicle during driving in an autonomous driving mode, using an apparatus that is mounted in a vehicle provided with the autonomous driving mode and includes a storage portion and a hardware processor that cooperates with the storage portion, the storage portion including a determination signal information storage portion configured to store information regarding an input signal for determining the intention of the driver to stop the vehicle, the method including:
acquiring a signal from a predetermined input portion provided in the vehicle during driving in the autonomous driving mode, by the hardware processor;

reading out the information regarding the input signal for determining the intention of the driver to stop the vehicle from the determination signal information storage portion, by the hardware processor;
determining the intention of the driver to stop the vehicle based on the acquired signal from the predetermined input portion, and the information regarding the input signal for determining the intention of the driver to stop the vehicle, by the hardware processor; and outputting a signal for giving an instruction to stop the vehicle through autonomous driving to an autonomous driving control portion that performs control in the autonomous driving mode, by the hardware processor, if it is determined that the signal from the predetermined input portion is a signal indicating the intention of the driver to stop the vehicle.

With the above-described stop intention determination method, the intention of the driver to stop the vehicle is determined during driving in the autonomous driving mode, based on the input signal acquired from the predetermined input portion. If it is determined that the signal from the predetermined input portion is a signal indicating the intention of the driver to stop the vehicle, a signal for giving an instruction to stop the vehicle through autonomous driving is output to the autonomous driving control portion.

Accordingly, the vehicle can be stopped through autonomous driving control during the autonomous driving mode, without bothering the driver.

### BRIEF DESCRIPTION OF THE DRAWINGS

FIG. 1 is a block diagram illustrating a configuration of essential parts of an autonomous driving system that includes a stop intention determination apparatus according to Embodiment (1).

FIG. 2 is a block diagram illustrating a hardware configuration of a stop intention determination apparatus according to Embodiment (1).

FIG. 3 is a flowchart illustrating a first processing operation performed by a control unit in a stop intention determination apparatus according to Embodiment (1).

FIG. 4 is a flowchart illustrating a second processing operation performed by a control unit in a stop intention determination apparatus according to Embodiment (1).

FIG. 5 is a flowchart illustrating a third processing operation performed by a control unit in a stop intention determination apparatus according to Embodiment (1).

FIG. 6 is a flowchart illustrating a fourth processing operation performed by a control unit in a stop intention determination apparatus according to Embodiment (1).

FIG. 7 is a flowchart illustrating a fifth processing operation performed by a control unit in a stop intention determination apparatus according to Embodiment (1).

### DETAILED DESCRIPTION

Hereinafter, an embodiment of a stop intention determination apparatus and a stop intention determination method will be described based on the drawings. Note that the following embodiment is a specific example of the present invention and is technically limited in various ways. However, the scope of the present invention is not limited to the embodiment unless it is particularly stated in the following description that the present invention is limited.

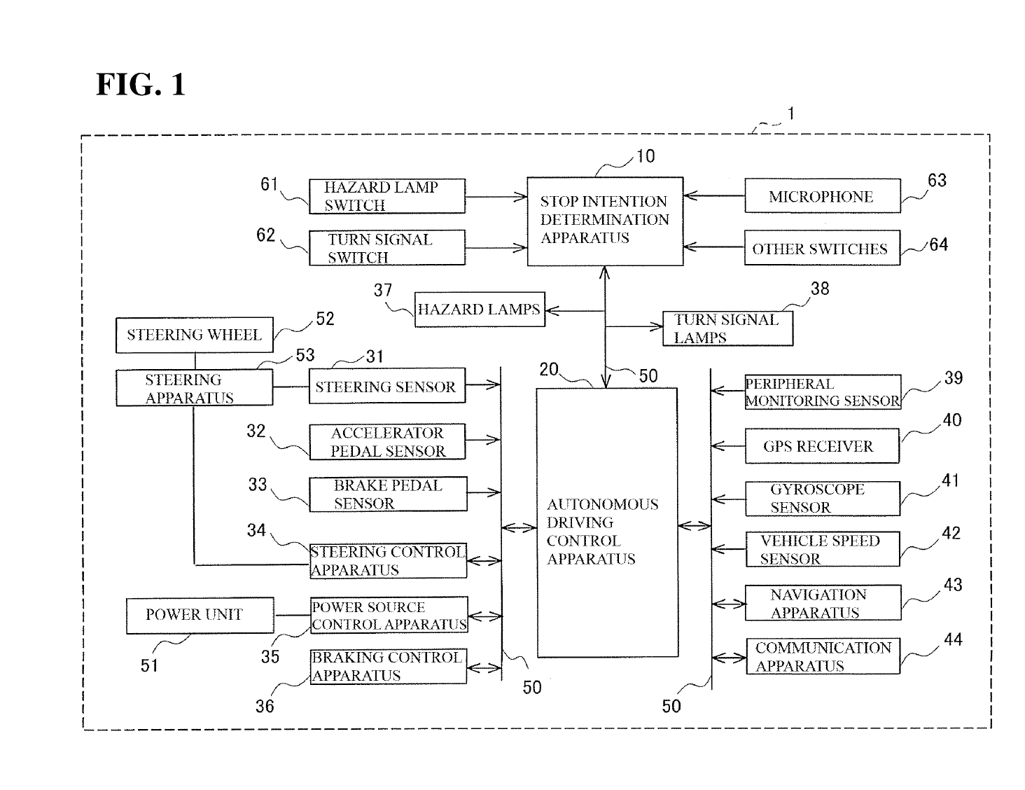

FIG. 1 is a block diagram showing a configuration of essential parts of an autonomous driving system that includes a stop intention determination apparatus according to Embodiment (1).

An autonomous driving system 1 includes a stop intention determination apparatus 10 and an autonomous driving control apparatus 20. The autonomous driving control apparatus 20 has a configuration for switching between an autonomous driving mode, in which at least part of traveling control that includes acceleration and deceleration, steering, and braking of a vehicle is autonomously performed by the system, and a manual driving mode, in which a driver performs driving operations. Note that the autonomous driving control apparatus 20 may also perform fully autonomous driving control during which the driver is not involved in driving.

The autonomous driving system 1 not only includes the stop intention determination apparatus 10 and the autonomous driving control apparatus 20, but also sensors, control apparatuses, and the like that are required for various kinds of control of autonomous driving and manual driving, such as a steering sensor 31, an accelerator pedal sensor 32, a brake pedal sensor 33, a steering control apparatus 34, a power source control apparatus 35, a braking control apparatus 36, hazard lamps 37, turn signal lamps 38, a peripheral monitoring sensor 39, a GPS receiver 40, a gyroscope sensor 41, a vehicle speed sensor 42, a navigation apparatus 43, and a communication apparatus 44. These various sensors and control apparatuses are connected to one another via a communication line 50.

The vehicle is also equipped with a power unit 51, which includes power sources such as an engine and a motor, and a steering apparatus 53 that includes a steering wheel 52, which is steered by the driver. A hardware configuration of the stop intention determination apparatus 10 will be described later.

The autonomous driving control apparatus 20 is an apparatus that executes various kinds of control associated with autonomous driving of the vehicle, and is constituted by an electronic control unit that includes a control portion, a storage portion, an input portion, an output portion, and the like, which are not shown in the diagrams. The control portion includes one or more hardware processors, reads out a program stored in the storage portion, and executes various kinds of vehicle control.

The autonomous driving control apparatus 20 is not only connected to the stop intention determination apparatus 10 but also to the steering sensor 31, the accelerator pedal sensor 32, the brake pedal sensor 33, the steering control apparatus 34, the power source control apparatus 35, the braking control apparatus 36, the peripheral monitoring sensor 39, the GPS receiver 40, the gyroscope sensor 41, the vehicle speed sensor 42, the navigation apparatus 43, the communication apparatus 44, and so on. Based on information acquired from these portions, the autonomous driving control apparatus 20 outputs control signals for performing autonomous driving to the control apparatuses, and performs autonomous traveling control (autonomous steering control, autonomous speed adjustment control, autonomous braking control etc.) of the vehicle.

Autonomous driving refers to allowing a vehicle to autonomously travel on a road under the control performed by the autonomous driving control apparatus 20, without a driver sitting in the driver seat and performing driving operations. For example, autonomous driving includes a driving state in which the vehicle is allowed to autonomously travel in accordance with a preset route to a destination, a travel route that is automatically generated based on a situation outside the vehicle and map information, or the like. The autonomous driving control apparatus 20 ends (cancels) autonomous driving if predetermined conditions for canceling autonomous driving are satisfied. For example, the autonomous driving control apparatus 20 ends autonomous driving if it is determined that the vehicle that is subjected to autonomous driving has arrived at a predetermined end point of autonomous driving. The autonomous driving control apparatus 20 may also perform control to end autonomous driving if the driver performs an autonomous driving canceling operation (e.g. an operation to an autonomous driving cancel button, an operation to a steering wheel, an accelerator, or a brake made by the driver etc.). Manual driving refers to driving in which the driver performs driving operations to cause the vehicle to travel.

The steering sensor 31 is a sensor for detecting the amount of steering performed with the steering wheel 52, is provided on, for example, a steering shaft of the vehicle, and detects the steering torque applied to the steering wheel 52 by the driver or the steering angle of the steering wheel 52. A signal that corresponds to a steering wheel operation performed by the driver detected by the steering sensor 31 is output to the autonomous driving control apparatus 20 and the steering control apparatus 34.

The accelerator pedal sensor 32 is a sensor for detecting the amount by which an accelerator pedal (position of the accelerator pedal) is pressed with a foot, and is provided on, for example, a shaft portion of the accelerator pedal. A signal that corresponds to the amount by which the accelerator pedal is pressed with a foot detected by the accelerator pedal sensor 32 is output to the autonomous driving control apparatus 20 and the power source control apparatus 35.

The brake pedal sensor 33 is a sensor for detecting the amount by which the brake pedal is pressed with a foot (position of the brake pedal) or the operational force (foot pressing force etc.) applied thereon. A signal that corresponds to the amount by which the brake pedal is pressed with a foot or the operational force detected by the brake pedal sensor 33 is output to the autonomous driving control apparatus 20 and the braking control apparatus 36.

The steering control apparatus 34 is an electronic control unit for controlling the steering apparatus (e.g. electric power steering device) 53 of the vehicle. The steering control apparatus 34 controls the steering torque of the vehicle by driving a motor for controlling the steering torque of the vehicle. In the autonomous driving mode, the steering torque is controlled in accordance with a control signal from the autonomous driving control apparatus 20.

The power source control apparatus 35 is an electronic control unit for controlling the power unit 51. The power source control apparatus 35 controls the driving force of the vehicle by controlling, for example, the amounts of fuel and air supplied to the engine, or the amount of electricity supplied to the motor. In the autonomous driving mode, the driving force of the vehicle is controlled in accordance with a control signal from the autonomous driving control apparatus 20.

The braking control apparatus 36 is an electronic control unit for controlling a brake system of the vehicle. The braking control apparatus 36 controls the braking force applied to wheels of the vehicle by adjusting the hydraulic pressure applied to a hydraulic pressure brake system, for example. In the autonomous driving mode, the braking force applied to the wheels is controlled in accordance with a control signal from the autonomous driving control apparatus 20.

The hazard lamps 37 are lamps that blink in accordance with an operation made to a hazard lamp switch 61. A pair of hazard lamps 37 are arranged in each of a front portion, rear portion, and side portion of the vehicle, for example. All hazard lamps 37 blink if the hazard lamp switch 61 is operated.

The turn signal lamps 38 are lamps that blink in accordance with an operation made to a turn signal switch 62. A pair of turn signal lamps 38 are arranged in each of a front portion, rear portion, and side portion of the vehicle, for example. Either the left or right turn signal lamps 38 blink in accordance with the direction of an operating lever of the turn signal switch 62.

The peripheral monitoring sensor 39 is a sensor for detecting a target object that is present around the vehicle. The target object may be, for example, a moving object such as a car, a bicycle, or a person, a marker on a road surface (white line etc.), a guard rail, a median strip, or other structures that may affect travel of the vehicle. The peripheral monitoring sensor 39 includes at least one of a front monitoring camera, a rear monitoring camera, a radar, a LIDER, i.e. a Light Detection and Ranging or Laser Imaging Detection and Ranging, and an ultrasonic sensor. Detection data, i.e. data on a target object detected by the peripheral monitoring sensor 39 is output to the autonomous driving control apparatus 20 and so on. A stereo camera, a monocular camera, or the like may be employed as the front monitoring camera and the rear monitoring camera. The radar detects the position, direction, distance, and the like of a target object by transmitting radio waves, such as millimeter waves, to the periphery of the vehicle, and receiving radio waves reflected off a target object that is present around the vehicle. The LIDER detects the position, direction, distance, and the like of a target object by transmitting a laser beam to the periphery of the vehicle and receiving a light beam reflected off a target object that is present around the vehicle.

The GPS receiver 40 is an apparatus that performs processing (GPS navigation) to receive a GPS signal from an artificial satellite via an antenna (not shown) and identify the vehicle position based on the received GPS signal. Information regarding the vehicle position identified by the GPS receiver 40 is output to the autonomous driving control apparatus 20, the navigation apparatus 43, and so on.

The gyroscope sensor 41 is a sensor for detecting the rotational angular speed (yaw rate) of the vehicle. A rotational angular speed signal detected by the gyroscope sensor 41 is output to the autonomous driving control apparatus 20, the navigation apparatus 43, and so on.

The vehicle speed sensor 42 is a sensor for detecting the vehicle speed and the distance of movement, and is constituted by, for example, a wheel speed sensor that is provided on a wheel, a drive shaft, or the like, and detects the rotational speed of the vehicle. The vehicle speed signal detected by the vehicle speed sensor 42 is output to the autonomous driving control apparatus 20, the navigation apparatus 43, and so on, and is used to detect the rotational speed of the wheels, travel distance, or vehicle speed.

Based on information regarding the vehicle position measured by the GPS receiver 40 or the like, and map information in a map database (not shown), the navigation apparatus 43 identifies the road and traffic lane on which the vehicle is traveling, calculates a route from the current vehicle position to a destination and the like, displays this route on a display portion (not shown), and provides audio output for route guidance or the like from an audio output portion (not shown). The vehicle position information, information regarding the road being traveled, scheduled traveling route information, and the like that are obtained by the navigation apparatus 43 are output to the autonomous driving control apparatus 20. The scheduled traveling route information also includes information associated with autonomous driving switching control, such as a start point and an end point of an autonomous driving zone, and an autonomous driving start notification point and an autonomous driving end (cancellation) notification point. The navigation apparatus 43 is configured to include a control portion, a display portion, an audio output portion, an operation portion, and a map data storage portion, and so on, which are not shown in the diagrams.

The communication apparatus 44 is an apparatus for acquiring various kinds of information via a wireless communication network (e.g. a communication network such as a cellular phone network, VICS (registered trademark), or DSRC (registered trademark). The communication apparatus 44 may also include an inter-vehicle communication function or a road-vehicle communication function. For example, road environment information regarding a course of the vehicle (traffic lane restriction information etc.) can be acquired through road-vehicle communication with a road-side transceiver (e.g. light beacon, ITS spot (registered trademark)) or the like that is provided on a road side. Also, information regarding other vehicles (position information, information regarding traveling control etc.), road environment information detected by other vehicles, and so on can be acquired through inter-vehicle communication.

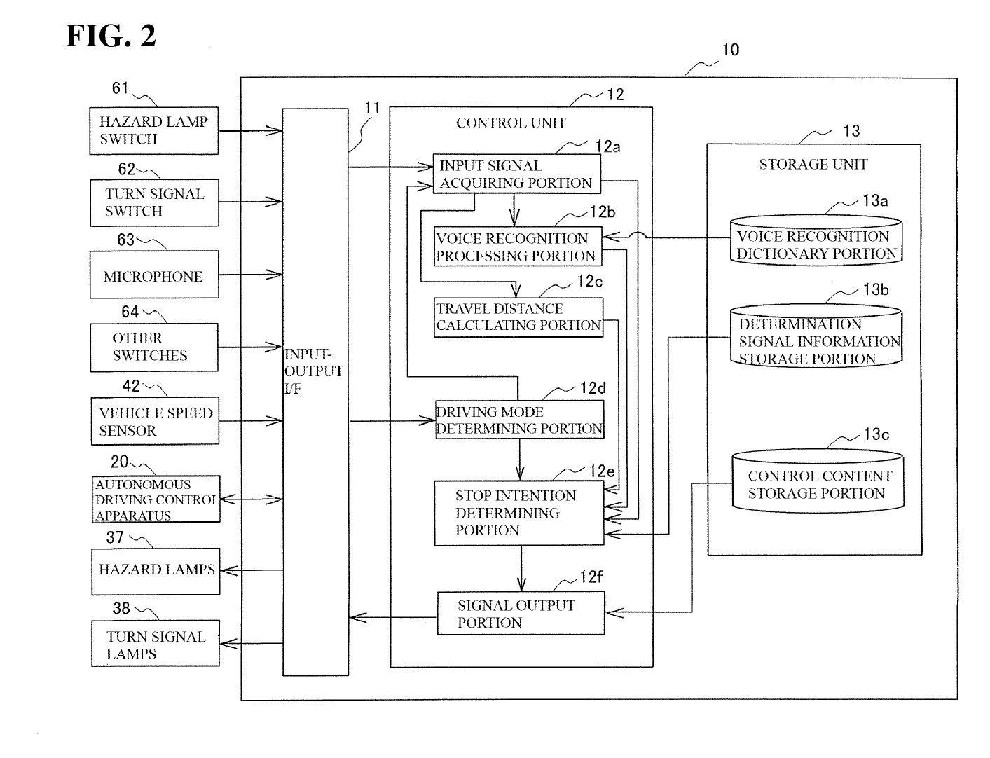

A hardware configuration of the stop intention determination apparatus 10 according to Embodiment (1) will be described based on the block diagram shown in FIG. 2.

The stop intention determination apparatus 10 is configured to include an input-output interface (I/F) 11, a control unit 12, and a storage unit 13.

The input-output I/F 11 is connected to input portions, namely the hazard lamp switch 61, the turn signal switch 62, a microphone 63 (voice input portion) for inputting voice, and other switches 64, as well as to the vehicle speed sensor 42, the autonomous driving control apparatus 20, the hazard lamps 37, the turn signal lamps 38, and so on, and is configured to include circuits, connectors, and the like for exchanging signals with these external devices.

The control unit 12 is configured to include an input signal acquiring portion 12a, a voice recognition processing portion 12b, a travel distance calculating portion 12c, a driving mode determining portion 12d, a stop intention determining portion 12e, and a signal output portion 12f, and is constituted by one or more hardware processors, such as a central processing unit (CPU).

The storage unit 13 is configured to include a voice recognition dictionary portion 13a, a determination signal information storage portion 13b, and a control content storage portion 13c, and is configured to include one or more memory devices for storing data using semiconductor devices, such as a read only memory (ROM), a random access memory (RAM), a solid-state drive (SSD), a hard disk drive (HDD), a flash memory, and other nonvolatile memories and volatile memories. The storage unit 13 stores a stop intention determination program, which is to be executed by the stop intention determining portion 12e.

The voice recognition dictionary portion 13a in the storage unit 13 stores dictionary data required in voice recognition processing, which is to be executed by the voice recognition processing portion 12b, i.e. dictionary data of voice signals for determining an intention of the driver to stop the vehicle, and the like.

The determination signal information storage portion 13b stores information regarding an input signal for determining an intention of the driver to stop the vehicle. For example, the determination signal information storage portion 13b stores information regarding the number of times that the hazard lamps 37 blink, blinking time, and travel distance during the blinking, and the like, as information regarding the signal from the hazard lamp switch 61 for determining an intention of the driver to stop the vehicle. The determination signal information storage portion 13b also stores information regarding the number of times that the turn signal lamps 38 blink, blinking time, and travel distance during the blinking, and the like, as information regarding the signal from the turn signal switch 62 for determining an intention of the driver to stop the vehicle.

The control content storage portion 13c stores data that is output from the signal output portion 12f in the control unit 12 regarding the content of control performed for external devices, such as the autonomous driving control apparatus 20, the hazard lamps 37, and the turn signal lamps 38.

The control unit 12 is configured to cooperate with the storage unit 13 to perform processing to store data required for control in the storage unit 13, as well as to read out the stop intention determination program and data required to execute this program that are stored in the storage unit 13, and execute the program.

The driving mode determining portion 12d, which is included in the control unit 12, executes processing to determine the driving mode, which may be the autonomous driving mode or the manual driving mode, for example, based on an autonomous driving mode setting signal, an autonomous driving mode cancel notification signal, an autonomous driving mode cancel signal, and the like, which are acquired from the autonomous driving control apparatus 20. The autonomous driving mode setting signal is a signal that is output after the setting of (switching to) the autonomous driving mode has been completed. The autonomous driving mode cancel notification signal is a signal that is output before the autonomous driving mode is switched to the manual driving mode (if a manual driving operation takeover zone is entered). The autonomous driving mode cancel signal is a signal that is output after the autonomous driving mode has been canceled and switched to the manual driving mode.

If it is determined by the driving mode determining portion 12d that the current driving mode is the autonomous driving mode, the input signal acquiring portion 12a executes processing to acquire a switch input signal from the hazard lamp switch 61, the turn signal switch 62, or other switches 64 and detect the number of times that the hazard lamps 37 or the turn signal lamps 38 blink, blinking time, and the like. The input signal acquiring portion 12a also executes processing to acquire a voice input signal from the microphone 63.

If the input signal acquiring portion 12a acquires a voice input signal from the microphone 63, the voice recognition processing portion 12b reads out the dictionary data stored in the voice recognition dictionary portion 13a, and executes voice recognition processing based on the read dictionary data. Any known voice recognition processing technique may be employed in the voice recognition processing.

The travel distance calculating portion 12c executes processing to calculate the distance by which the vehicle travels while the input signals from various switches are detected by the input signal acquiring portion 12a.

The stop intention determining portion 12e executes processing to determine whether or not the driver intends to stop the vehicle.

Initially, if it is determined by the driving mode determining portion 12d that the current driving mode is the autonomous driving mode, and the input signal acquiring portion 12a acquires a switch input signal from the hazard lamp switch 61 or the turn signal switch 62, or a voice input signal from the microphone 63, the stop intention determining portion 12e executes processing to read out information regarding the input signal for determining an intention of the driver to stop the vehicle from the determination signal information storage portion 13b, or the dictionary data for determining an intention of the driver to stop the vehicle from the voice recognition dictionary portion 13a. Next, the stop intention determining portion 12e executes processing to determine whether or not the driver intends to stop the vehicle, based on the acquired switch input signal or voice input signal, and the information regarding the input signal (including voice signal) for determining an intention of the driver to stop the vehicle.

The signal output portion 12f outputs a predetermined signal that is based on the determination result from the stop intention determining portion 12e. For example, if the determination result from the stop intention determining portion 12e indicates that the driver intends to stop the vehicle, the signal output portion 12f outputs a control signal for stopping the vehicle through autonomous driving at a safe place, such as a road shoulder, to the autonomous driving control apparatus 20. On the other hand, if the determination result indicates that the driver does not intend to stop the vehicle, the signal output portion 12f may output a signal for permitting continuation of the autonomous driving mode to the autonomous driving control apparatus 20, or may not output any signal.

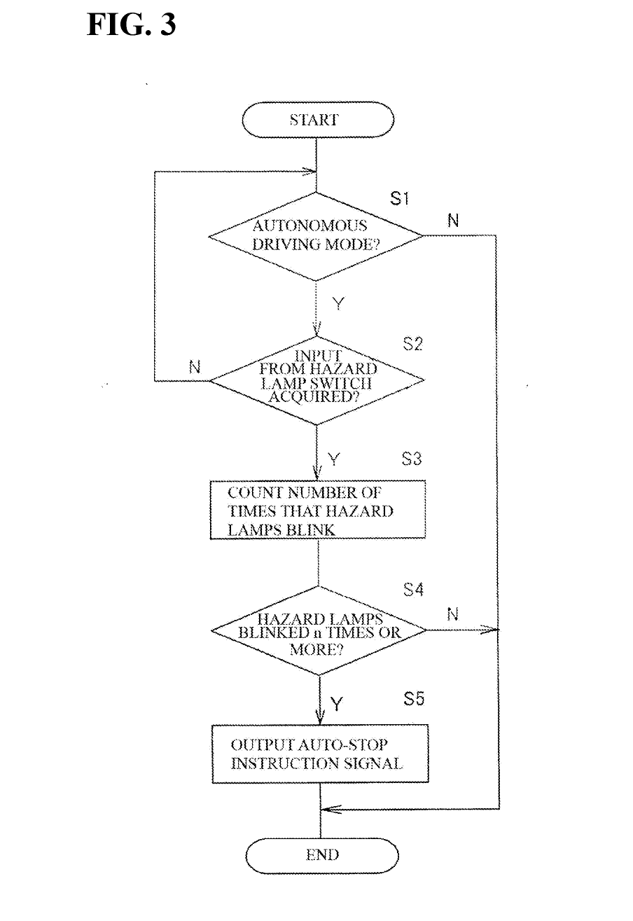

FIG. 3 is a flowchart showing a first processing operation performed by the control unit 12 in the stop intention determination apparatus 10 according to Embodiment (1). This processing operation is executed in the case where the vehicle is set to the autonomous driving mode.

Initially, in step S1, whether or not the current driving mode is the autonomous driving mode is determined. For example, this determination is performed based on an autonomous driving mode setting signal that is transmitted from the autonomous driving control apparatus 20. If it is determined in step S1 that the current driving mode is not the autonomous driving mode (e.g. is the manual driving mode), the processing then ends. On the other hand, if it is determined that the current driving mode is the autonomous driving mode, the processing proceeds to step S2.

In step S2, whether or not an input signal from the hazard lamp switch 61 has been acquired is determined. If it is determined that an input signal from the hazard lamp switch 61 has not been acquired, the processing returns to step S1. On the other hand, if it is determined that an input signal from the hazard lamp switch 61 has been acquired, the processing proceeds to step S3. In step S3, processing is performed to count the number of times that the hazard lamps 37 blink, based on the input signal from the hazard lamp switch 61, and the processing then proceeds to step S4.

In step S4, information regarding the input signal from the hazard lamp switch 61 for determining an intention of the driver to stop the vehicle (a signal in a state of causing the hazard lamps 37 to blink a predetermined number of times (n times) or more) is read out from the determination signal information storage portion 13b, and whether or not the input signal from the hazard lamp switch 61 is a signal for causing the hazard lamps 37 to blink the predetermined number of times (n times) or more is determined.

The predetermined number of times is set to the number of times that indicates an intention of the driver to stop the vehicle, and can be set to the number of times that can be distinguished from a switch operation to cause the hazard lamps 37 to blink about twice for a short time to express gratitude to a nearby vehicle that has given way, e.g. about three to five times, but is not limited thereto. Not only a lower limit value but also an upper limit value of the number of times (the range of the number of times) may also be set. A determination number-of-times setting portion that allows the predetermined number of times to be set to any number of times in accordance with preference or habit of the driver may also be provided.

If it is determined in step S4 that the input signal is not a signal for causing the hazard lamps 37 to blink the predetermined number of times (n times) or more, i.e. the input signal indicates the aforementioned blinking of the hazard lamps 37 to express gratitude, or an erroneous operation, the processing then ends. On the other hand, if it is determined that the input signal is a signal for causing the hazard lamps 37 to blink the predetermined number of times (n times) or more, i.e. the driver intends to stop the vehicle, the processing proceeds to step S5.

In step S5, processing is performed to output a signal for giving an instruction to stop the vehicle through autonomous driving control (i.e. a signal indicating an intention of the driver to stop the vehicle) to the autonomous driving control apparatus 20, and the processing then ends. Upon receiving an auto-stop instruction signal from the stop intention determination apparatus 10, the autonomous driving control apparatus 20 executes control to automatically sets a place at which the vehicle can safely stop, causes turn signal lamps 38 indicating a road shoulder direction in which the vehicle is to stop to blink, and stop the vehicle at the set place through autonomous driving.

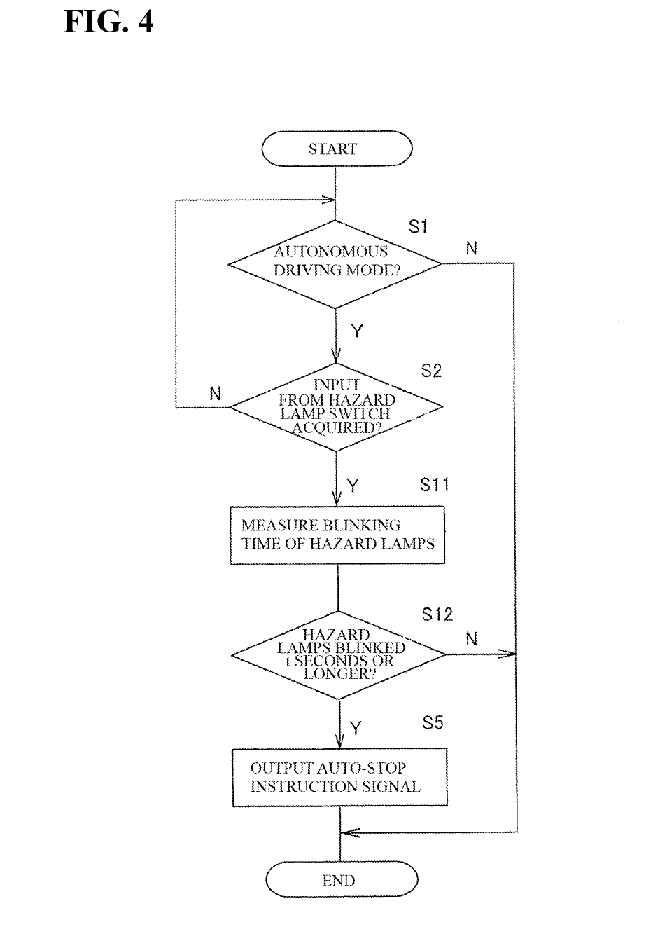

FIG. 4 is a flowchart showing a second processing operation performed by the control unit 12 in the stop intention determination apparatus 10 according to Embodiment (1). Note that processing steps with the same content as that in the above-described first processing operation are assigned the same signs, and descriptions thereof will be omitted.

If it is determined in step S2 that an input signal from the hazard lamp switch 61 has been acquired, the processing proceeds to step S11. In step S11, the blinking time of the hazard lamps 37 is measured based on the input signal from the hazard lamp switch 61.

In the next step S12, information regarding the input signal from the hazard lamp switch 61 for determining an intention of the driver to stop the vehicle (a signal in a state of causing the hazard lamps 37 to blink for a predetermined time (t seconds) or longer) is read out from the determination signal information storage portion 13b, and whether or not the input signal from the hazard lamp switch 61 is a signal for causing the hazard lamps 37 to blink for the predetermined time (t seconds) or longer is determined.

The predetermined time is set to a time that indicates an intention of the driver to stop the vehicle. For example, the predetermined time can be set to a time (specifically, a time from about three to five seconds or longer) that can be distinguished from a switch operation to cause the hazard lamps 37 to blink about twice for a short time to express gratitude to a nearby vehicle that has given way, but is not limited thereto. A determination time setting portion that allows the predetermined time to be set to any time in accordance with preference or habit of the driver may also be provided.

If it is determined in step S12 that the blinking time of the hazard lamps 37 is not the predetermined time (t seconds) or longer, i.e. the blinking time indicates the aforementioned blinking to express gratitude, as mentioned above, or is an erroneous operation, the processing then ends. On the other hand, if it is determined in step S12 that the blinking time of the hazard lamps 37 is the predetermined time (t seconds) or longer, i.e. the driver intends to stop the vehicle, the processing then proceeds to step S5, the auto-stop instruction signal is transmitted to the autonomous driving control apparatus 20, and the processing then ends.

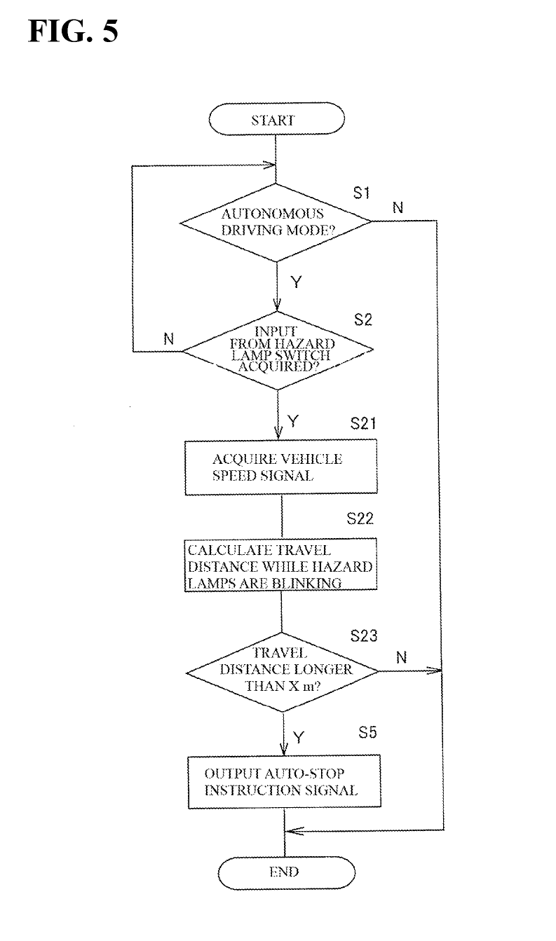

FIG. 5 is a flowchart showing a third processing operation performed by the control unit 12 in the stop intention determination apparatus 10 according to Embodiment (1). Note that processing steps with the same content as that in the above-described first processing operation are assigned the same signs, and descriptions thereof will be omitted.

If it is determined in step S2 that an input signal from the hazard lamp switch 61 has been acquired, the processing proceeds to step S21. In step S21, a vehicle speed signal for measuring the travel distance is acquired from the vehicle speed sensor 42. In the next step S22, processing is performed to calculate the travel distance after the input signal from the hazard lamp switch 61 is detected (while the hazard lamps 37 are blinking), based on the acquired vehicle speed signal. Then, the processing proceeds to step S23.

In step S23, information regarding the input signal from the hazard lamp switch 61 for determining an intention of the driver to stop the vehicle (travel distance (X m) that is traveled after the hazard lamp switch 61 has been turned on) is read out from the determination signal information storage portion 13b. Then, whether or not the calculated travel distance has reached a predetermined distance (X m) is determined. The predetermined distance is set to a distance that indicates an intention of the driver to stop the vehicle, and can be set to a distance, e.g. in a range from about 20 m to 30 m or longer, that can be distinguished from a switch operation to cause the hazard lamps 37 to blink about twice for a short time to express gratitude to a nearby vehicle that has given way, for example, but is not limited thereto. The predetermined distance may also be set in accordance with the vehicle speed so as to be longer the higher the vehicle speed is, for example. A determination distance setting portion that allows the predetermined distance to be set to any distance in accordance with preference or habit of the driver may also be provided.

If it is determined in step S23 that the travel distance has not reached the predetermined distance (X m), i.e. the distance indicates the aforementioned blinking to express gratitude, or an erroneous operation, the processing then ends. On the other hand, if it is determined that the travel distance has reached the predetermined distance (X m), i.e. the driver intends to stop the vehicle, the processing proceeds to step S5, the auto-stop instruction signal is transmitted to the autonomous driving control apparatus 20, and the processing then ends.

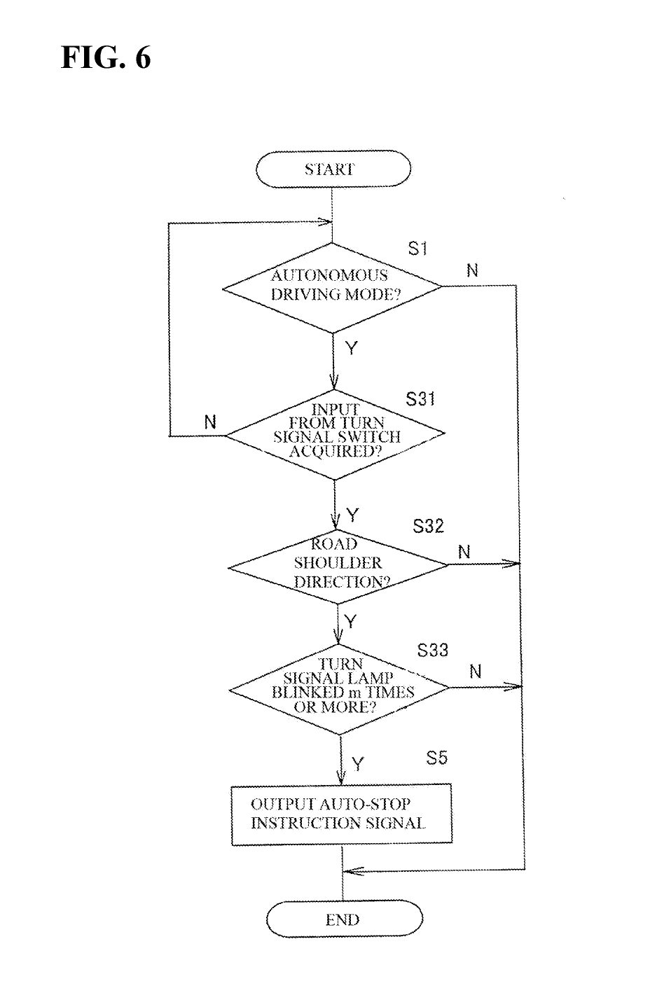

FIG. 6 is a flowchart showing a fourth processing operation performed by the control unit 12 in the stop intention determination apparatus 10 according to Embodiment (1). Note that processing steps with the same content as that in the above-described first processing operation are assigned the same signs, and descriptions thereof will be omitted.

If it is determined in step S1 that the current driving mode is the autonomous driving mode, the processing proceeds to step S31. In step S31, whether or not an input signal from the turn signal switch 62 has been acquired is determined. If it is determined that an input signal from the turn signal switch 62 has not been acquired, the processing returns to step S1. On the other hand, if it is determined that an input signal from the turn signal switch 62 has been acquired, the processing proceeds to step S32.

In step S32, whether or not the input signal from the turn signal switch 62 is a signal for causing the turn signal lamps 38 indicating the road shoulder direction to blink is determined. If it is determined that the input signal is not a signal for causing the turn signal lamps 38 indicating the road shoulder direction to blink, i.e. is a signal for causing the turn signal lamps 38 indicating an opposite lane side or a passing lane side to blink, the processing then ends.

On the other hand, if it is determined in step S32 that the input signal is a signal for causing the turn signal lamps 38 indicating the road shoulder direction to blink, the processing proceeds to step S33. Note that the determination of whether or not the road shoulder direction is indicated may be performed using vehicle position information or driving lane information acquired from the navigation apparatus 43, for example.

In step S33, information regarding the input signal from the turn signal switch 62 (a signal in a state of causing the turn signal lamps 38 to blink a predetermined number of times (m times) or more) for determining an intention of the driver to stop the vehicle is read out from the determination signal information storage portion 13b, and whether or not the input signal from the turn signal switch 62 is a signal for causing the turn signal lamps 38 to blink the predetermined number of times (m times) or more is determined.

The predetermined number of times is set to the number of times that indicates an intention of the driver to stop the vehicle, and can be set to the number of times that can be distinguished from an operation to cause the turn signal lamps 38 to blink before changing the lane or turning left or right, e.g. about 10 times, but is not limited thereto. A determination number-of-times setting portion that allows the predetermined number of times to be set to any number of times in accordance with preference or habit of the driver may also be provided.

If it is determined in step S33 that the input signal is not a signal for causing the turn signal lamps 38 to blink the predetermined number of times (m times) or more, i.e. the input signal is given due to an erroneous operation or the like, the processing then ends. On the other hand, if it is determined that the input signal is a signal for causing the turn signal lamps 38 to blink the predetermined number of times (m times) or more, i.e. the driver intends to stop the vehicle, the processing proceeds to step S5, the auto-stop instruction signal is transmitted to the autonomous driving control apparatus 20, and the processing then ends.

Note that a configuration may also be employed in which, instead of the processing in step S33 in the above-described fourth processing operation, processing is executed to determine whether or not the input signal from the turn signal switch 62 is a signal for causing the turn signal lamps 38 to blink for a predetermined time or longer.

A configuration may also be employed in which, instead of the processing in step S33, processing is executed to determine whether or not the travel distance after the input signal from the turn signal switch 62 has been acquired (i.e. during the turn signal lamps 38 are blinking) is longer than or equal to a predetermined distance.

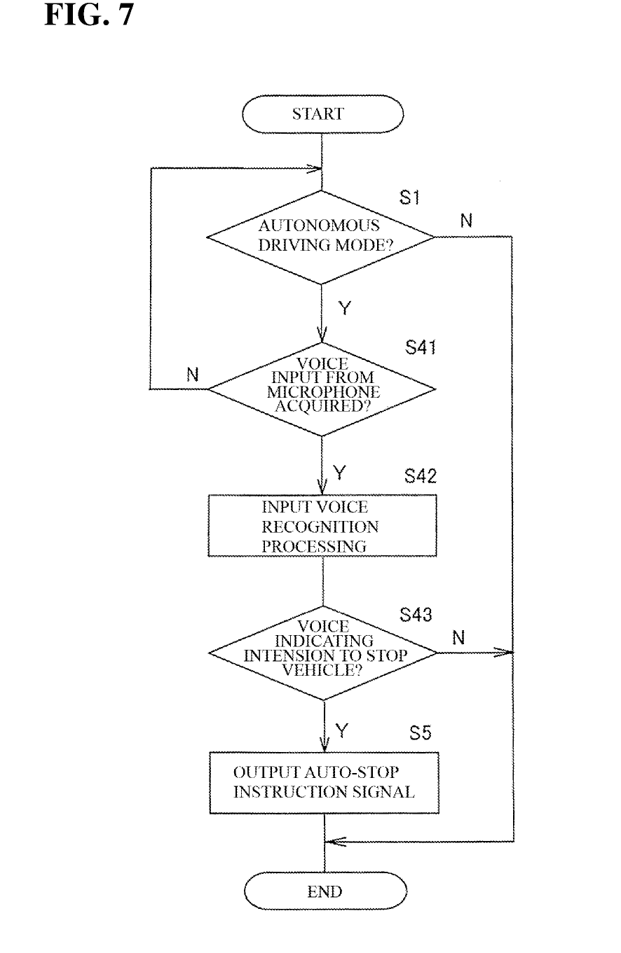

FIG. 7 is a flowchart showing a fifth processing operation performed by the control unit 12 in the stop intention determination apparatus 10 according to Embodiment (1). Note that processing steps with the same content as that in the above-described first processing operation are assigned the same signs, and descriptions thereof will be omitted.

If it is determined in step S1 that the current driving mode is the autonomous driving mode, the processing proceeds to step S41. In step S41, whether or not an input voice from the microphone 63 has been acquired is determined. If it is determined that an input voice from the microphone 63 has not been acquired, the processing returns to step S1. On the other hand, if it is determined that an input voice from the microphone 63 has been acquired, the processing proceeds to step S42.

In step S42, processing is performed to recognize the input voice, and the processing then proceeds to step S43. In step S43, whether or not the voice recognition processing result indicates that the input voice is a voice that indicates an intention of the driver to stop the vehicle (e.g. “Stop on a road shoulder.” etc.) is determined. Voice dictionary data of a voice that indicates an intention of the driver to stop the vehicle is stored in the voice recognition dictionary portion 13a. Note that a voice dictionary registering portion may also be provided to which the driver (user) can input and register, using the microphone 63, the voice that indicates an intention to stop the vehicle and is to be stored as the voice dictionary data in the voice recognition dictionary portion 13a.

If it is determined in step S43 that the input voice is not the voice that indicates an intention of the driver to stop the vehicle, the processing then ends. On the other hand, if it is determined that the input voice is the voice that indicates an intention of the driver to stop the vehicle, i.e. the driver intends to stop the vehicle, the processing proceeds to step S5, the auto-stop instruction signal is transmitted to the autonomous driving control apparatus 20, and the processing then ends.

With the stop intention determination apparatus 10 according to Embodiment (1) described above, an intention of the driver to stop the vehicle is determined during driving in the autonomous driving mode, based on a signal (such as a switch input signal or voice input signal) from the hazard lamp switch 61, the turn signal switch 62, or the microphone 63 that is acquired by the input signal acquiring portion 12a. If it is determined that the acquired signal indicates an intention of the driver to stop the vehicle, the auto-stop instruction signal is output to the autonomous driving control apparatus 20. Accordingly, the vehicle can be stopped through autonomous driving control during the autonomous driving mode, without bothering the driver.

Also, with the stop intention determination apparatus 10, if the input signal from the hazard lamp switch 61 is a signal in a state of causing the hazard lamps 37 to blink a predetermined number of times (three to five times) or more, or for a predetermined time (three to five seconds) or longer, or a signal with which the travel distance while the hazard lamps 37 are blinking reaches the predetermined distance, it is determined that the driver intends to stop the vehicle. Accordingly, an intention of the driver to stop the vehicle can be determined, in distinction from blinking of the hazard lamps once or twice or a short time (about two seconds) to express gratitude to a nearby vehicle that has given way or the like. Since the hazard lamp switch 61 is provided in usual vehicles, the use of the hazard lamp switch 61 requires no new operation switch to be provided in a vehicle, and the area for providing operation switches can be reduced. Furthermore, since the hazard lamp switch 61 usually allows people to imagine stopping of a vehicle, the driver does not need to memorize special operations or functions to carry out one or more embodiments, and a user-friendly apparatus can be provided.

Also, with the stop intention determination apparatus 10, an intention of the driver to stop the vehicle is determined during driving in the autonomous driving mode, based on the result of recognizing a voice that is input from the microphone 63. If it is determined that the voice recognized by the voice recognition processing portion 12b indicates an intention of the driver to stop the vehicle, a signal for giving an instruction to stop the vehicle through autonomous driving is output to the autonomous driving control apparatus 20. Accordingly, the vehicle can be stopped through autonomous driving control during the autonomous driving mode by inputting a voice from the microphone 63, without bothering the driver.

Also, with the stop intention determination apparatus 10, if an input signal from the turn signal switch 62 is a signal in a state of causing the turn signal lamps 38 indicating the road shoulder direction to blink and causing the turn signal lamps 38 to blink a predetermined number of times or more, or for a predetermined time or longer, it is determined that the driver intends to stop the vehicle. Accordingly, an intention of the driver to stop the vehicle can be determined, in distinction from a course change toward a passing lane, for example. Accordingly, the vehicle can be stopped through autonomous driving control based on an operation state of the turn signal switch 62 during the autonomous driving mode, without bothering the driver. Since the turn signal switch 62 is provided in usual vehicles, the use of the turn signal switch 62 requires no new operation switch to be provided in a vehicle, and the area for providing operation switches can be reduced. Moreover, since the turn signal switch 62 is usually for notifying nearby people of an intention of the driver to change the course, for example, the driver does not need to memorize special operations or functions to carry out one or more embodiments, and a user-friendly apparatus can be provided.

Note that a configuration may also be employed in which, for example, a dedicated button switch for stopping the vehicle during autonomous driving is provided in the other switches 64, or a touch switch for stopping the vehicle during autonomous driving is provided in a display operation menu in the navigation apparatus 43 or the like, and the auto-stop instruction signal is output to the autonomous driving control apparatus 20 if an input signal is detected from this dedicated button switch or touch switch during autonomous driving.

In the above-described stop intention determination apparatus 10, the control unit 12 is configured to be able to execute the above-described first to fifth processing operations. However, in one or more embodiments, the control unit 12 may also be configured to be able to execute at least one of the first to fifth processing operations.

(Note 1)

A stop intention determination apparatus that is mounted in a vehicle provided with an autonomous driving mode and determines an intention of a driver to stop the vehicle during driving in the autonomous driving mode, the apparatus including:

a memory including a determination signal information storage portion that stores information regarding an input signal for determining the intention of the driver to stop the vehicle; and at least one hardware processor connected to the memory, wherein the at least one hardware processor is configured to:

acquire a signal from a predetermined input portion provided in the vehicle during driving in the autonomous driving mode;

read out the information regarding the input signal for determining the intention of the driver to stop the vehicle from the determination signal information storage portion;

determine the intention of the driver to stop the vehicle based on the acquired signal from the predetermined input portion and the information regarding the input signal for determining the intention of the driver to stop the vehicle; and output a signal for giving an instruction to stop the vehicle through autonomous driving to an autonomous driving control portion that performs control during the autonomous driving mode, if it is determined that the signal from the predetermined input portion is a signal indicating the intention of the driver to stop the vehicle.

(Note 2)

A stop intention determination method for determining an intention of a driver to stop a vehicle during driving in an autonomous driving mode, using an apparatus that is mounted in a vehicle provided with the autonomous driving mode and includes a memory including a determination signal information storage portion that stores information regarding an input signal for determining the intention of the driver to stop the vehicle, and at least one hardware processor connected to the memory, the method including:

acquiring a signal from a predetermined input portion provided in the vehicle during driving in the autonomous driving mode, by the at least one hardware processor;

reading out information regarding an input signal for determining the intention of the driver to stop the vehicle from the determination signal information storage portion, by the at least one hardware processor;

determining the intention of the driver to stop the vehicle based on the acquired signal from the predetermined input portion, and the information regarding the input signal for determining the intention of the driver to stop the vehicle, by the at least one hardware processor; and outputting a signal for giving an instruction to stop the vehicle through autonomous driving to an autonomous driving control portion that performs control during the autonomous driving mode, if it is determined that the signal from the predetermined input portion is a signal indicating the intention of the driver to stop the vehicle, by the at least one hardware processor.

1. A stop intention determination apparatus that is mounted in a vehicle provided with an autonomous driving mode and determines an intention of a driver to stop the vehicle during driving in the autonomous driving mode, the apparatus comprising:
an input signal acquiring portion configured to acquire a signal from a predetermined input portion provided in the vehicle during driving in the autonomous driving mode;
a stop intention determining portion configured to determine the intention of the driver to stop the vehicle based on the signal from the predetermined input portion acquired by the input signal acquiring portion; and
a signal output portion configured to output a signal for giving an instruction to stop the vehicle through autonomous driving to an autonomous driving control portion that performs control in the autonomous driving mode, if it is determined by the stop intention determining portion that the signal from the predetermined input portion is a signal indicating the intention of the driver to stop the vehicle.

2. The stop intention determination apparatus according to claim 1,
wherein the predetermined input portion is a hazard lamp switch provided in the vehicle, and
the stop intention determining portion determines the intention of the driver to stop the vehicle based on a state of an input signal from the hazard lamp switch acquired by the input signal acquiring portion.

3. The stop intention determination apparatus according to claim 2,
wherein, if the input signal from the hazard lamp switch is a signal in a state of causing a hazard lamp to blink a predetermined number of times or more, or for a predetermined time or longer, the stop intention determining portion determines that the driver intends to stop the vehicle.

4. The stop intention determination apparatus according to claim 2, further comprising:
a travel distance calculating portion configured to calculate a travel distance of the vehicle,
wherein, if the travel distance calculated by the travel distance calculating portion reaches a predetermined distance while the input signal from the hazard lamp switch is acquired by the input signal acquiring portion, the stop intention determining portion determines that the driver intends to stop the vehicle.

5. The stop intention determination apparatus according to claim 1,
wherein the predetermined input portion is a voice input portion provided in the vehicle,
the stop intention determination apparatus further comprises a voice recognition processing portion configured to perform processing to recognize a voice signal from the voice input portion acquired by the input signal acquiring portion, and
if a voice recognized by the voice recognition processing portion is a voice indicating an intention to stop the vehicle, the stop intention determining portion determines that the driver intends to stop the vehicle.

6. The stop intention determination apparatus according to claim 1,
wherein the predetermined input portion is a turn signal switch provided in the vehicle, and
the stop intention determining portion determines the intention of the driver to stop the vehicle based on a state of an input signal from the turn signal switch acquired by the input signal acquiring portion.

7. The stop intention determination apparatus according to claim 6,
wherein, if the input signal from the turn signal switch is a signal in a state of causing a turn signal lamp indicating a road shoulder direction to blink, and causing the turn signal lamp to blink a predetermined number of times or more, or for a predetermined time or longer, the stop intention determining portion determines that the driver intends to stop the vehicle.

8. A stop intention determination method for determining an intention of a driver to stop a vehicle during driving in an autonomous driving mode, using an apparatus that is mounted in a vehicle provided with the autonomous driving mode and includes a storage portion and a hardware processor that cooperates with the storage portion,
the storage portion including a determination signal information storage portion configured to store information regarding an input signal for determining the intention of the driver to stop the vehicle,
the method comprising:
acquiring a signal from a predetermined input portion provided in the vehicle during driving in the autonomous driving mode, by the hardware processor;
reading out the information regarding the input signal for determining the intention of the driver to stop the vehicle from the determination signal information storage portion, by the hardware processor;
determining the intention of the driver to stop the vehicle based on the acquired signal from the predetermined input portion, and the information regarding the input signal for determining the intention of the driver to stop the vehicle, by the hardware processor; and
outputting a signal for giving an instruction to stop the vehicle through autonomous driving to an autonomous driving control portion that performs control in the autonomous driving mode, by the hardware processor, if it is determined that the signal from the predetermined input portion is a signal indicating the intention of the driver to stop the vehicle.
